(19) United States
(12) Patent Application Publication
(10) Pub. No.: US 2014/0335216 A1
(43) Pub. Date: Nov. 13, 2014

(54) STRIP-SHAPED MOLD CAVITY FOR PRODUCING SURFACE MATERIALS AND METHOD FOR PRODUCING A STRIP-SHAPED MOLD CAVITY

(71) Applicant: Heinz Haller, Plochingen (DE)

(72) Inventor: Heinz Haller, Plochingen (DE)

(73) Assignee: Sueddekor GmbH, Laichingen (DE)

(21) Appl. No.: 14/239,550

(22) PCT Filed: Jun. 13, 2012
(86) PCT No.: PCT/EP2012/061155

§ 371 Date: Jun. 16, 2014

(30) Foreign Application Priority Data
Aug. 19, 2011 (DE) 10 2011 052 834.2

(51) Int. Cl. B29C 43/36; B32B 38/00

(52) U.S. Cl. CPC B29C 43/36; B32B 38/0036
USPC 425/470; 156/272.8

(57) ABSTRACT

A web-shaped matrix for the production of surface materials, particularly surfaces during the production of laminate panels, having a structured surface, a flexible carrier web layer particularly made of paper or film and a layer separating from the surface material arranged on the side of the surface material, wherein the structured surface is arranged on the side of the separating layer facing away from the surface material.

### BACKGROUND OF THE INVENTION

The invention relates to a web-shaped matrix for the production of surface materials, particularly surfaces during the production of laminate panels. In addition, the invention relates to a method of manufacturing a web-shaped matrix.

A matrix of this kind known to the applicant from EP 1 017 555 B1, for example, has a carrier web layer made of paper, for example, to which a separating layer against the surface material is applied. In turn, a structured surface made of UV-hardening printing inks is applied. The composite thereby produced from a flexible carrier web layer, separating layer and structured surface is hardened by electron beam processing.

Moreover, separating papers having a separating layer on the side (front side) turned towards the surface material, which is mechanically stamped in a further process stage, are known from the literature.

Web-shaped matrices with a carrier web made of paper, to which a separating coating material is applied, are known in the art, wherein a stamping is formed in the still liquid coating by stamped rollers or structural films.

A common characteristic of all web-shaped matrices known from the art is that the separating layer and the structured surface (structural layer) are located on the side (front side) of the carrier web layer facing the surface material. The disadvantage of this is that through the arrangement of the separating layer and the structural layer, which is usually applied as a separate layer, the two layers just referred to have to be accurately aligned with one another. The production of relatively deep structures in the structural layers is particularly problematic in this case, since a structural layer of this kind requires a relatively large quantity of coating material with binding agents which, moreover, is relatively expensive or else laborious because it must have separating properties on the side facing the surface material. In particular, the silicon acrylates used to produce the separating properties, for example, cost four to five times the binding agents of the structured layer.

### SUMMARY OF THE INVENTION

Starting with the state of the art as represented, the problem addressed by the invention is that of developing a web-shaped matrix for the production of surface materials, particularly surfaces during the production of laminate panels and a method of manufacturing a matrix in such a manner that particularly cost-effective production can be achieved, wherein, moreover, the matrix should exhibit particularly good material properties. This problem is solved according to the invention by a web-shaped matrix or a method of manufacturing a matrix as disclosed herein wherein the structured surface is arranged on the side of the separating layer facing away from the surface material. The idea on which the invention is based in this case is that a structured surface produces structuring in the carrier web layer when the structured surface is transferred onto the surface material, which is usually performed by pressing plates, press rolls or similar, which in turn produces the desired structure on the surface of the surface material.

Advantageous developments of the matrix according to the invention or the method of manufacture thereof are disclosed herein. All combinations of at least two features disclosed in the claims, the description and/or the figures fall within the framework of the invention.

In a first realization of this general basic idea underlying the invention, it is proposed in concrete terms that the structured surface is designed in the form of a structural layer separate from the carrier web layer and is arranged on the side of the carrier web layer facing away from the separating layer. Three layers are therefore used in this realization—the separating layer, the carrier web layer and the structural layer. A configuration of this kind has the advantage that the two layers arranged on opposite sides of the carrier web layer to one another can each be optimized in their own right, i.e. that particularly the structural layer, for example, no longer needs to have any separating properties, as is required in the state of the art. In this way, the use of relatively expensive separating means in the structural layer, in particular, can be dispensed with.

The consequence of this is that in a further embodiment the structural layer may contain up to 80% by vol. filler materials and/or residual paint. A high degree of filler materials of this kind cannot be achieved in practice with a structural layer that simultaneously exhibits separating features.

Moreover, the two-sided coating of the carrier web layer means that a relatively thin paper can be used for the carrier web layer, which has a weight of 70 g/m², for example, according to a concrete embodiment. Moreover, the use of thin paper of this kind has the particular advantage that not only can costs be reduced, but the relatively thin carrier web layer means that the structure to be transferred onto the surface material stands out particularly clearly.

In a further embodiment of the carrier web layer, it is proposed that said layer additionally contains (apart from paper) a plastic layer, preferably comprising polyester.

In order to configure the structural layer particularly economically, accurately and simply, it is furthermore proposed that said structural layer is configured as a digital structural layer and comprises an ink jet printer-capable material.

It is particularly preferable in this case for the material of the structural layer to be EB-curable and preferably configured as a monomer.

While the concrete embodiments of the matrix described hitherto envisage the use of three separate layers (separating layer, carrier web layer, structural layer), a further alternative concrete embodiment of the invention is provided in that the structured surface is configured in the carrier web layer. A separate structural layer can thereby be dispensed with.

In concrete terms, it is proposed in a realization of the basic ideas underlying the invention just referred to that the structured surface is produced by a laser ablation process in the carrier web layer. A structured surface can thereby be produced with great accuracy and can be changed relatively quickly in terms of its structure through a corresponding setting of the laser, so that relatively small quantities of web-shaped matrices can also be manufactured relatively economically, wherein this already applies to the first concrete embodiment of the invention.

It is specifically proposed in this respect that the carrier web layer is made at least partly, preferably completely, from paper and has a thickness of 100 μm to 300 μm, preferably of roughly 200 μm. A thickness of the carrier web layer of this kind allows production of the structured surface with the desired structural depth.

### BRIEF DESCRIPTION OF THE DRAWINGS

Further advantages, features and details of the invention result from the following description of preferred exemplary embodiments and also using the description.

In the figures:

FIG. 1 shows a cross section through a partial region of a web-shaped matrix for producing surface materials with a first embodiment of the invention prior to pressing with a surface material,

FIG. 2 shows the matrix according to FIG. 1 during pressing with a surface material, likewise in cross section,

FIG. 3 shows an alternative embodiment of a web-shaped matrix using a structured carrier web layer prior to pressing with a surface material and

FIG. 4 shows the matrix according to FIG. 3 during pressing.

### DETAILED DESCRIPTION

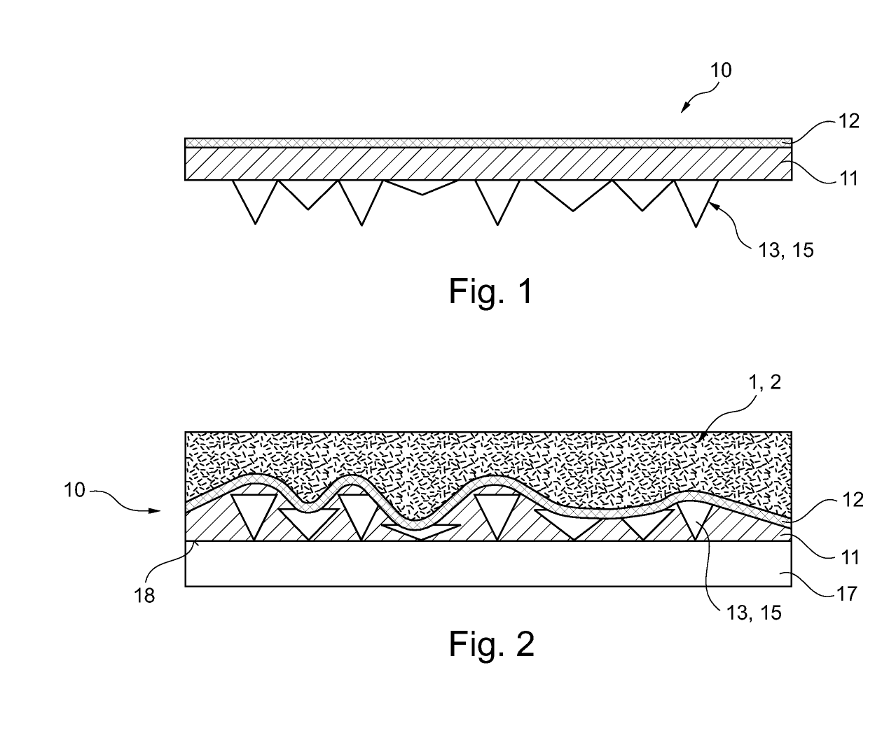

A first web-shaped matrix 10, as can be used to produce surface materials, particularly surfaces during the production of laminate panels 1, is depicted in FIG. 1. The matrix 10 has three layers: A centrally arranged carrier web layer 11 which is preferably made of paper or film, wherein when paper is used this may also contain a plastic layer, preferably polyester. If only paper is used, this typically has a weight of 70 g/m².

On the side facing the surface material of the laminate panel 1, the carrier web layer 11 is provided with a separating layer 12, preferably in the form of a coating. The separating layer 12 is planar in design, wherein customary components of a separating agent layer are provided for the material of the separating layer, i.e. said layer exhibits separating properties, particularly with respect to the material used of the laminate panel 1 arranged in active connection with the matrix 10.

On the side of the carrier web layer 11 opposite the separating layer 12, a structured surface 13 in the form of a structural layer 15 separate from the carrier web layer 11 is arranged. It is preferably provided that the structural layer 15, which may exhibit structures with a maximum height of typically 90 μm, for example, comprises EB-curable, ink jet printer-capable materials, particularly monomers, which are applied to the carrier web layer 11 as a digital structural layer 15. Furthermore, it is preferably provided that the structural layer 15 contains up to 80% filler substances and/or residual paint.

A matrix 10 according to the invention configured in this manner is pressed by means of a pressing plate 17 shown in FIG. 2 against the surface material of a laminate panel 1 only depicted with its melamine layer 2. Instead of a pressing plate 17, a pressing roller or similar can of course also be used.

Depicted in FIG. 2 is the state in which the matrix 10 has already been pressed with the laminate panel 1. It is clear in this case that as a consequence of the pressing force of the pressing plate 17, the structured surface 13 or else the structure layer 15 has moved into the carrier web layer 11 in such a manner that the carrier web layer 11 exhibits a flat surface 18 on the side facing the pressing plate 17. Due to the height and thickness of the structural layer 15, the carrier web layer 11 became deformed in the corresponding regions of the structural layer 15, wherein said layer was not damaged, however. At the same time, the separating layer 12 has adjusted on the side facing the laminate panel 1 to the shape of the carrier web layer 11, so that a corresponding structure of the structural layer 15 was stamped into the melamine layer 2 of the laminate panel 1.

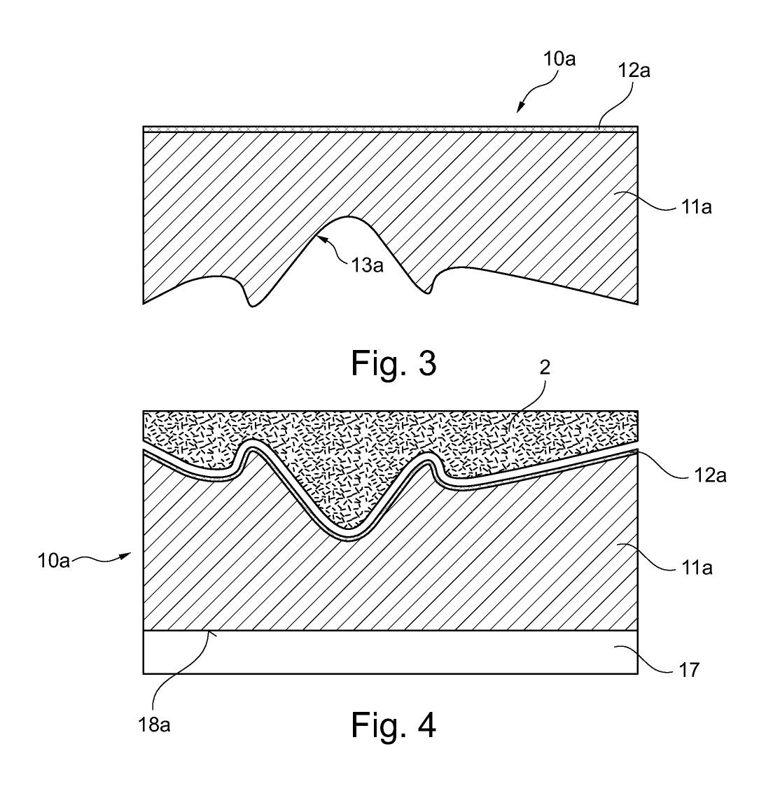

A modified embodiment of the invention is depicted in FIGS. 3 and 4 using a matrix 10a. Unlike the matrix 10, the matrix 10a only comprises two layers—a carrier web layer 11a and a separating layer 12a. The properties (material and thickness) of the separating layer 12a may correspond to the properties of the separating layer 12 of the matrix 10 in this case. The carrier web layer 11a comprises paper with a thickness of between 100 μm and 300 μm, preferably of roughly 200 μm, for example.

FIG. 3 shows the state in which the matrix 10a has not yet been brought into connection with the surface material of the laminate panel 1 to be structured. It is essential that on the side of the carrier web layer 11a facing away from the separating layer 12a, a structured surface 13a has been produced in the carrier web layer 11a, which has particularly been configured by a laser ablation process.

FIG. 4 shows the state of the matrix 10a after the pressing of the pressing plate 17 against the melamine layer 2 of the laminate panel 1, for example. It is evident that the surface of the carrier web layer 11a has been levelled on the side facing the pressing plate 17, i.e. that by analogy with the matrix 10, a level surface 18a exists. By contrast, the structured surface 13a in the melamine layer 2 stands out on the side facing the melamine layer 2, wherein where the smallest material wear existed in the structured surface 13a, these regions stand out in the melamine layer 2 as particularly large depressions.

The matrices 10, 10a according to the invention described so far may be converted or modified in a plurality of ways without deviating from the basic idea underlying the invention. This involves not arranging a structured surface 13, 13a on a separating layer 12, 12a of a matrix 10, 10a, but on the side of the separating layer 12, 12a facing away from the surface layer, either as a (separate) structural layer 15 or through stamping or structuring of a carrier web layer 11a.

1. A web-shaped matrix (10, 10a) for the production of surface materials, particularly surfaces during the production of laminate panels (1), having a structured surface (13; 13a), a flexible carrier web layer (11; 11a) particularly made of paper or film and a layer (12; 12a) separating from the surface material (2) arranged on the side of the surface material (2),
wherein
the structured surface (13; 13a) is arranged on the side of the separating layer (12; 12a) facing away from the surface material (2).

2. The matrix according to claim 1, wherein the structured surface (13) surface is designed in the form of a structural layer (15) separate from the carrier web layer (11) and is arranged on the side of the carrier web layer (11) facing away from the separating layer (12).

3. The matrix according to claim 2, wherein the structural layer (15) contains up to 80% by vol. filler materials and/or residual paint.

4. The matrix according to claim 2, wherein the carrier web layer (11) is made of paper with a weight of 70 g/m².

5. The matrix according to claim 4, wherein the carrier web layer (11) additionally contains a plastic layer, preferably exhibiting polyester.

6. The matrix according to that claim 2, wherein the structural layer (15) is configured as a digital structural layer and comprises an ink jet printer-capable material.

7. The matrix according to claim 6, wherein the material of the structural layer (15) is EB-curable and preferably configured as a monomer.

8. The matrix according to claim 1, wherein the structured surface (13a) is configured in the carrier web layer (11a).

9. The matrix according to claim 8, wherein the structured surface (13a) is produced by a laser ablation process in the carrier web layer (11a).

10. The matrix according to claim 8, wherein the carrier web layer (11a) is made at least partly from paper and has a thickness of 100 μm to 300 μm.

11. A method of manufacturing a web-shaped matrix (10; 10a) for the production of surface materials, particularly surfaces during the production of laminate panels (1), wherein a structured surface (13; 13a) is provided with a flexible carrier web layer (11; 11a) and a layer (12; 12a) separating from the surface material (2) arranged on the side of the surface material (2), wherein
the structured surface (13; 13a) is arranged on the side of the separating layer (12; 12a) facing away from the surface material (2).

12. The method according to claim 11, wherein the structured surface (13a) is configured in the carrier web layer (11a).

13. The method according to claim 12, wherein the structured surface (13a) is produced by a laser ablation process in the carrier web layer (11a).

14. The matrix according to claim 1, wherein the flexible carrier web layer (11; 11a) is made of paper or film.

15. The matrix according to claim 10, wherein the carrier web layer (11a) is made completely from paper.

16. The matrix according to claim 10, wherein the carrier web layer (11a) has a thickness of roughly 200 μm.

17. The method according to claim 11, wherein the flexible carrier web layer (11; 11a) is made of paper or film.
